(19) United States
(12) Patent Application Publication
(10) Pub. No.: US 2015/0031784 A1
(43) Pub. Date: Jan. 29, 2015

(54) METHOD TO PREVENT DEACTIVATION OF METAL CATALYSTS IN CATALYTIC POLYMERISATION PROCESSES

(71) Applicant: Janssen Pharmaceutica, NV, Beerse (BE)

(72) Inventor: Kurt Mark Anthony De Meyer, Beerse (BE)

(73) Assignee: Janssen Pharmaceutica, NV, Beerse (BE)

(21) Appl. No.: 14/376,819

(22) PCT Filed: Feb. 7, 2013
(86) PCT No.: PCT/EP2013/052395

§ 371 Date: Aug. 5, 2014

(30) Foreign Application Priority Data
Feb. 8, 2012 (EP) 12154447.2

(51) Int. Cl. C08F 2/38; C08F 2/44

(52) U.S. Cl. CPC C08F 2/38; C08F 2/44
USPC 523/122

(57) ABSTRACT

The present invention relates to a method to prevent deactivation of the metal catalyst in a catalytic polymerisation process of polymeric binders whereby pyrithione biocides are present which method comprises the addition of a Zn, Cu or Na salt selected from Zn, Cu or Na salts of fatty acids such as e.g. Zn, Cu or Na octoate, Zn, Cu or Na acrylate, Zn, Cu or Na neodecanoate, or Zn, Cu or Na salts of beta diketones such as e.g. Zn, Cu or Na acetylacetonate.

The present invention relates to a method to prevent deactivation of the metal catalyst in a catalytic polymerisation process of polymeric binders whereby pyrithione biocides are present which method comprises the addition of a Zn, Cu or Na salt selected from Zn, Cu or Na salts of fatty acids such as e.g. Zn, Cu or Na octoate; Zn, Cu or Na acrylate; Zn, Cu or Na neodecanoate; or Zn, Cu or Na salts of beta diketones such as e.g. Zn, Cu or Na acetylacetonate.

Pyrithione biocides such as e.g. zinc pyrithione, copper pyrithione, and sodium pyrithione are excellent broad-spectrum antimicrobial agents and are used as a biocide and preservative in fluids, paints, cosmetics etc.

Many plastic polymerization reactions are accelerated via metal catalysts (e.g., Pt, Co, Ag, Mg, . . . ). Besides the basic polymerization reactants, often specific additives (anti-oxidants, anti-statics, flame retardants, pigments, fillers, antimicrobials, . . . ) are incorporated in such plastic polymers, which should not significantly interfere with the catalyst. Additives with (trans)chelating properties, on the other hand, can dramatically disturb or even completely block the polymerization reaction by binding the metal catalyst thereby deactivating its catalytic properties. An example of such additives with (trans)chelating properties are the pyrithione biocides zinc pyrithione, copper pyrithione, and sodium pyrithione. In order to prevent the deactivation of the metal catalyst during the polymerization reaction, a suitable stabilizing agent should be added to the polymerization reaction in sufficient amounts, in order to shift the chelation of the catalyst towards chelation of the added metal of the metal salt.

It has now been found that the addition of suitable Zn, Cu or Na salts selected from Zn, Cu or Na salts of fatty acids such as e.g. Zn, Cu or Na octoate; Zn, Cu or Na acrylate; Zn, Cu or Na neodecanoate; or Zn, Cu or Na salts of beta diketones such as e.g. Zn, Cu or Na acetylacetonate, is helpful to prevent deactivation of the metal catalyst during the catalytic polymerisation process of polymeric binders.

Composite materials are engineered materials made from two or more constituent materials with significantly different physical or chemical properties which remain separate and distinct at the macroscopic or microscopic scale within the finished structure. In order to bind all constituent materials together a matrix material is used which is often a polymeric material obtained by a catalytic polymerisation process of polymeric binders. It can be beneficial to add a pyrithione biocide to such composite materials and in order to prevent deactivation of the metal catalyst during the catalytic polymerisation process one or more Zn, Cu or Na salts selected from Zn, Cu or Na salts of fatty acids such as e.g. Zn, Cu or Na octoate; Zn, Cu or Na acrylate; Zn, Cu or Na neodecanoate; or Zn, Cu or Na salts of beta diketones such as e.g. Zn, Cu or Na acetylacetonate can be added in accordance with the present invention.

An example of composite materials are e.g. fiber reinforced polyester ship hulls whereby a pyrithione biocide is added to prevent fouling.

The polymeric binder used in the catalytic polymerisation process of the present invention may be formed of a polymer, a mixture of polymers (for example, polyester and urethane), monomers, and mixtures of monomers and polymers. Examples of suitable polymers include polyester, unsaturated polyester, vinyl ester, epoxy, phenolic resin, urethane and mixtures thereof. Examples of monomers for the polymeric binder include alpha, beta-ethylenically unsaturated monomers, e.g., styrene and styrene derivatives; lower alkyl substituted styrenes; alpha-methyl styrene; vinyl toluene; divinyl benzene; acrylics; C₁₋₁₈alkyl esters of acrylic and methacrylic acids, e.g., methyl acrylate, ethyl acrylate, isopropyl acrylate, butyl acrylate, 2-ethyl-hexyl acrylate, methyl methacrylate, ethyl methacrylate, isopropyl methacrylate, and butyl methacrylate; and phenols, furans and the like. These monomers may be used alone or in combination.

An often used polymeric binder is unsaturated polyester or unsaturated polyester resins (UP). Unsaturated polyester resins are solutions of unsaturated polyesters in copolymerizable monomers, preferably in styrene. Suitable unsaturated polyesters are the usual condensation products of polybasic, in particular dibasic carboxylic acids and their esterifiable derivatives, in particular their anhydrides, which are bonded in the way of an ester with polyhydric, in particular dihydric alcohols, and which may additionally contain residues of monobasic carboxylic acids or monohydric alcohols, with at least part of the starting materials being provided with ethylenically unsaturated, copolymerizable groups. Other unsaturated polyesters are those on the basis of maleic anhydride and orthophthalic acid or isophthalic acid, on the one hand, and propylene glycol, ethylene glycol, diethylene glycol and/or dipropylene glycol on the other hand.

Deactivation of the metal catalyst typically results in extended curing time or incomplete curing of the polymer formed in the catalytic polymerisation process. The addition of a Zn, Cu or Na salt in accordance with the present invention prevents deactivation of the metal catalyst resulting in reduced curing times.

The amount of a Zn, Cu or Na salt added in the catalytic polymerisation process is such that deactivation of the metal catalyst is prevented when pyrithione biocides are present so that curing time is not negatively impacted. In practice it has been found that the Zn, Cu or Na salt has to be added in an amount of at least a 0.1:1 weight ratio of Zn, Cu or Na salt vs. pyrithione biocide. A higher ratio of Zn, Cu or Na salt vs. pyrithione biocide has been found to yield shorter curing times. Typical weight/weight ratios in practice of Zn, Cu or Na salt vs. pyrithione biocide are 0.5:1, 1:1, 2:1, 3:1, 4:1, 5:1, 6:1, 10:1 up to 20:1 which gives the following ranges: 0.1:1 to 20:1; 0.5:1 to 20:1; 1:1 to 20:1; 2:1 to 20:1; 3:1 to 20:1; 4:1 to 20:1; 5:1 to 20:1; 10:1 to 20:1; and also 3:1 to 10:1; 4:1 to 10:1; 5:1 to 10:1.

When the pyrithione biocide is zinc pyrithione than preferably the zinc salts of the fatty acids or beta diketones are used selected from zinc octoate, zinc acrylate, zinc neodecanoate, and zinc acetylacetonate.

When the pyrithione biocide is copper pyrithione than preferably the copper salts of the fatty acids or beta diketones are used selected from copper octoate, copper acrylate, copper neodecanoate, and copper acetylacetonate.

When the pyrithione biocide is sodium pyrithione than preferably the sodium salts of the fatty acids or beta diketones are used selected from sodium octoate, sodium acrylate, sodium neodecanoate, and sodium acetylacetonate.

The pyrithione biocide and the Zn, Cu or Na salts of the present invention can be added separately to the catalytic polymerisation process whereby the sequence of addition can be first the pyrithione biocide followed by the Zn, Cu or Na salt, or it can be first the Zn, Cu or Na salt followed by the pyrithione biocide.

Alternatively the pyrithione biocide and the Zn, Cu or Na salts of the present invention can be added simultaneously to the catalytic polymerisation process either as separate products or as a combination product. Said combination product can be any formulation comprising both the pyrithione biocide and the Zn, Cu or Na salt together with any optional excipients.

### EXPERIMENTAL PART

### Experiment 1

### Polyester Polymer

### Sample Preparation:

weigh the amount of unsaturated polyester resin (=polymeric binder) into a glass beaker
add zinc pyrithione to the unsaturated polyester resin and homogenize by high-performance dispersing
add zinc salt to the unsaturated polyester resin and homogenize by high-performance dispersing
add cobalt catalyst to previous mixture and homogenize by gentle dispersing
add peroxide radical initiator to previous mixture and homogenize by gentle dispersing
pour the mixture into a glass casting and place sample at 80° C. in the oven to allow curing of the polymer

The reaction exotherms as a function of time were measured.

TABLE 1

| | Sample 1 | Sample 2 | Sample 3 |
|---|---|---|---|
| | Concentration | Concentration | Concentration |
| Composition | (% w/w) | (% w/w) | (% w/w) |
| Zinc pyrithione | 0.6 | 0.6 | 0.6 |
| Zinc salt | 1 | 2 | 4 |
| Co catalyst (6%) | 0.4 | 0.4 | 0.4 |
| Peroxide | 2 | 2 | 2 |
| Unsaturated | 96 | 95 | 93 |
| polyester resin | | | |

TABLE 2

| | Sample 4 | Sample 5 | Sample 6 |
|---|---|---|---|
| | Concentration | Concentration | Concentration |
| Composition | (% w/w) | (% w/w) | (% w/w) |
| Zinc pyrithione | 0.8 | 0.8 | 0.8 |
| Zinc salt | — | 4 | 8 |
| Co catalyst (6%) | 0.4 | 0.4 | 0.4 |
| Peroxide | 2 | 2 | 2 |
| Unsaturated | 96.8 | 92.8 | 88.8 |
| polyester resin | | | |

Co catalyst: Nusa cobalt™ 6% (CAS: 83711-44-8) commercially available from Nusa Ibérica S.A., Rio Tajuña 5, 28850 Torrejón de Ardoz, Madrid, Spain

Unsaturated polyester resin: Synolite 9286-N-0™ commercially available from DSM, Netherlands, which is a a low viscous monomer free unsaturated polyester resin

Zinc compound used:
zinc octoate
zinc acrylate
zinc neodecanoate
zinc acetylacetonate

The reaction exotherms as function of time for the samples 4, 5 and 6 has been depicted in FIG. 1. As can be seen from the reaction exotherms, the addition of the zinc octoate as a zinc salt resulted in a reduction of the curing time of the polyester polymer. Sample 4 (no zinc salt present) had a curing time of about 29 minutes, sample 5 (4% w/w zinc octoate) has a curing time of about 16 minutes and sample 6 (8% w/w zinc octoate) had a curing time of about 12 minutes.

FIG. 2 demonstrates two aspects:
a) the curing time of a sample with 0 ppm zinc pyrithione is much shorter (about 7 minutes) compared to the curing time of a sample with 6000 ppm zinc pyrithione (about 21 minutes)
b) a higher amount of zinc salt results in a more pronounced prevention of deactivation of the metal catalyst resulting in e.g. a faster curing time: the addition of 4% zinc octoate or 8% zinc octoate to a sample comprising 6% zinc pyrithione results in improved curing time to a sample comprising 6% zinc pyrithione without said zinc salts present

### DESCRIPTION OF THE DRAWINGS

FIG. 1: reaction exotherm as function of time for samples 4, 5 and 6

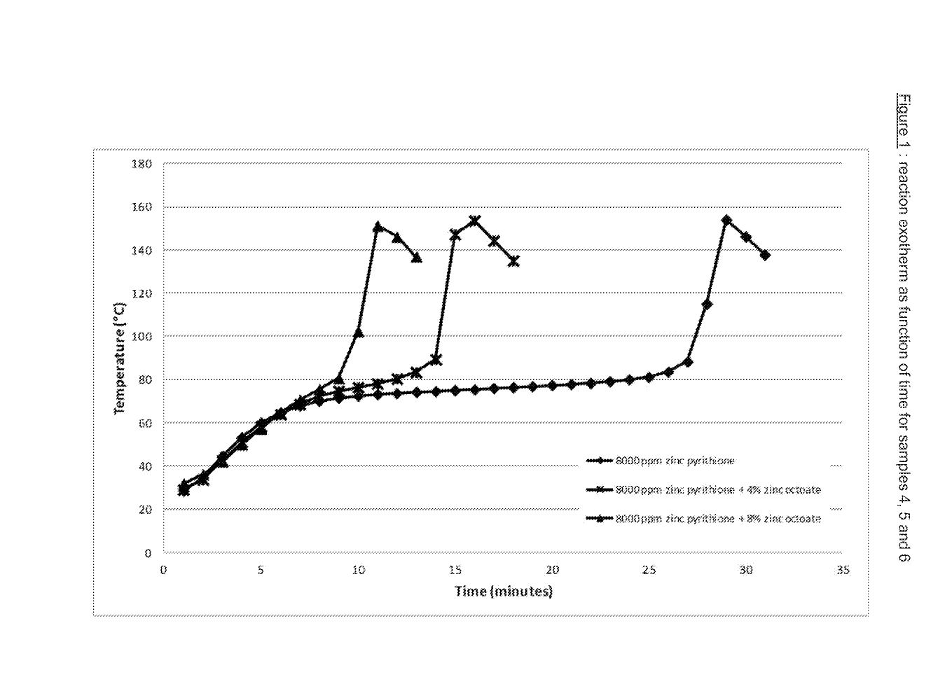

FIG. 2: reaction exotherm as function of time for samples comprising no zinc pyrithione; 0.6% zinc pyrithione; 0.6% zinc pyrithione +4% zinc octoate; and 0.6% zinc pyrithione +8% zinc octoate

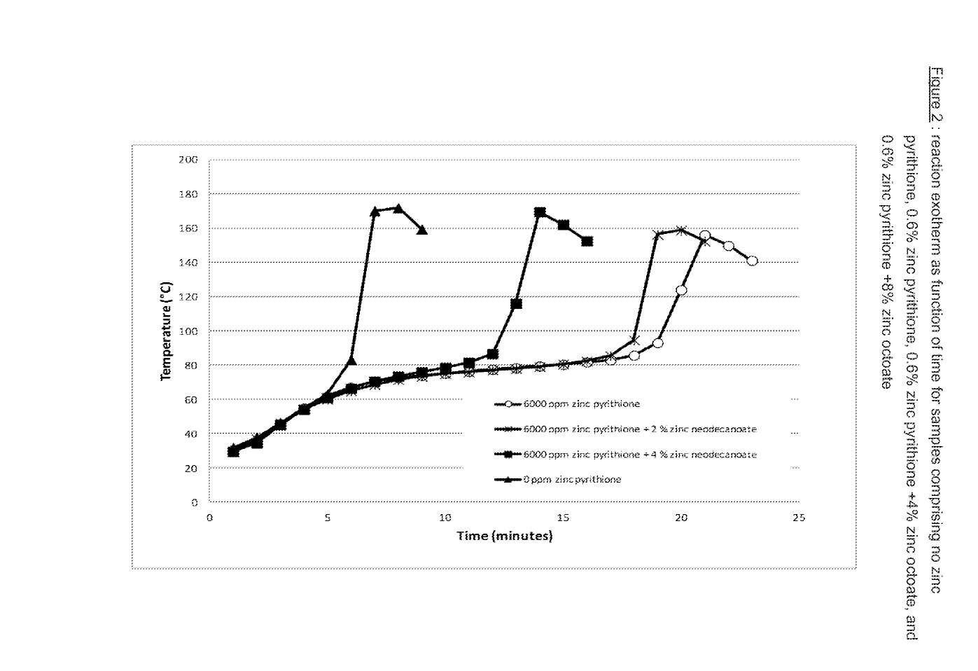

1. A method to prevent deactivation of a metal catalyst in a catalytic polymerisation process of polymeric binders whereby pyrithione biocides selected from zinc pyrithione, copper pyrithione, and sodium pyrithione, are present characterized by the addition of a suitable Zn, Cu or Na salt selected from Zn, Cu or Na salts of fatty acids or Zn, Cu or Na salts of beta diketones; whereby the Zn, Cu or Na salt is added in an amount of at least a 0.1:1 weight ratio of Zn, Cu or Na salt to pyrithione biocide.

2. The method according to claim 1 whereby the Zn, Cu or Na salt is added in an amount of at least a 3:1 weight ratio of Zn, Cu or Na salt to pyrithione biocide.

3. The method according to claim 2 wherein the Zn, Cu or Na salts of fatty acids are selected from Zn, Cu or Na octoate; Zn, Cu or Na acrylate; Zn, Cu or Na neodecanoate; and the Zn, Cu or Na salts of beta diketones are selected from Zn, Cu or Na acetylacetonate.

4. The method according to claim 3 wherein the weight/weight ratio of Zn, Cu or Na salt to pyrithione biocide ranges from 3:1 to 20:1.

5. The method according to claim 3 wherein the weight/weight ratio of Zn, Cu or Na salt to pyrithione biocide ranges from 3:1 to 10:1.

6. The method according to claim 3 wherein the weight/weight ratio of Zn, Cu or Na salt to pyrithione biocide is 5:1.

7. The method according to claim 3 wherein the weight/weight ratio of Zn, Cu or Na salt to pyrithione biocide is 10:1.

8. The method according to any one of the preceding claims wherein the pyrithione biocide is zinc pyrithione.

9. The method according to claim 8 wherein the Zn, Cu or Na salt is a Zn salt selected from zinc octoate, zinc acrylate, zinc neodecanoate, and zinc acetylacetonate.

10. The method according to claim 9 wherein the Zn, Cu or Na salt is a Zn salt selected from zinc octoate and zinc neodecanoate.

11. The method according to claim 1 wherein the pyrithione biocide and the Zn, Cu or Na salt are added separately to the catalytic polymerisation process.

12. The method according to claim 1 wherein the pyrithione biocide and the Zn, Cu or Na salt are added simultaneously to the catalytic polymerisation process.

13. The method according to claim 12 wherein the pyrithione biocide and the Zn, Cu or Na salt are added as a combination product to the catalytic polymerisation process.

14. The method according to claim 1 wherein the metal catalyst comprises cobalt.

15. The method according to claim 1 wherein the polymeric binder is an unsaturated polyester resin.
